(19) United States
(12) Patent Application Publication
(10) Pub. No.: US 2024/0022004 A1
(43) Pub. Date: Jan. 18, 2024

(54) ANTENNA STRUCTURE

(71) Applicant: KYOCERA Corporation, Kyoto-shi, Kyoto (JP)

(72) Inventor: Keizou SAKURAI, Yasu-shi (JP)

(73) Assignee: KYOCERA Corporation, Kyoto-shi, Kyoto (JP)

(21) Appl. No.: 18/038,553

(22) PCT Filed: Nov. 18, 2021
(86) PCT No.: PCT/JP2021/042474

§ 371 Date: May 24, 2023

(30) Foreign Application Priority Data
Nov. 27, 2020 (JP) 2020-197305

(51) Int. Cl. H01Q 19/02; H01Q 19/06; H01Q 1/22; H01Q 1/48; H01Q 1/38

(52) U.S. Cl. CPC H01Q 19/021; H01Q 19/06; H01Q 1/2283; H01Q 1/48; H01Q 1/38

(57) ABSTRACT

An antenna structure according to the present disclosure includes an antenna substrate including a first surface and a second surface located on an opposite side to the first surface, a transmissive filter located over the first surface, and control substrates located on the second surface. The transmissive filter includes first annular patterns located on a surface facing the first surface, and second annular patterns located on a surface on an opposite side to the surface facing the first surface. The first annular pattern and the second annular pattern are located overlapping each other in a plane perspective. The control substrates are identical in number to the first annular patterns, and are located overlapping the first annular patterns in a plane perspective.

### TECHNICAL FIELD

The present invention relates to an antenna structure.

### BACKGROUND OF INVENTION

Conventionally, a communication device that uses a wireless network includes an antenna structure as described in Patent Document 1, for example, for transmission and reception of electrical signals. Such an antenna structure has, for example, a structure in which an electric filter substrate is layered on an upper surface of a control substrate (RF control substrate) and an antenna substrate is layered on an upper surface of the electric filter substrate.

In the antenna structure described in Patent Document 1, the antenna substrate and the control substrate are connected via the electric filter substrate. This results in longer wiring lines and a higher transmission loss. In addition, since such an antenna structure has a layered structure, when connection failure or the like occurs, each of the antenna substrate, the electric filter substrate, and the control substrate cannot be reused. As a result, the yield is lowered. In order to avoid such defects, a relatively expensive low-dielectric material or low-loss material is employed, which leads to an increase in cost.

In the antenna structure described in Patent Document 1, the antenna substrate, the electric filter substrate, and the control substrate have substantially the same size in a plan view. Since such an antenna structure has the layered structure, each member cannot be applied with an arbitrary size according to an arrangement location. As a result, it is difficult to miniaturize the antenna structure.

### CITATION LIST

### Patent Literature

Patent Document 1: JP 6-152101 A

### SUMMARY

### Solution to Problem

An antenna structure according to the present disclosure includes an antenna substrate including a first surface and a second surface located on an opposite side to the first surface, a transmissive filter located over the first surface, and a control substrate located on the second surface. The transmissive filter includes a first annular pattern located on a surface facing the first surface, and a second annular pattern located on a surface on an opposite side to the surface facing the first surface. The first annular pattern and the second annular pattern are located overlapping each other in a plane perspective. The control substrate is identical in number to the first annular pattern, and is located overlapping the first annular pattern in a plane perspective.

### BRIEF DESCRIPTION OF THE DRAWINGS

FIG. 1 is an explanatory view illustrating an antenna structure according to an embodiment of the present disclosure.

FIGS. 2A to 2D are explanatory views for explaining an antenna substrate included in the antenna structure illustrated in FIG. 1, in which FIG. 2A is a top view illustrating an embodiment of an insulating substrate, FIG. 2B is a top view illustrating an embodiment of a first grounding conductor layer, FIG. 2C is a top view illustrating an embodiment of an insulating layer located on an uppermost surface, and FIG. 2D is a top view illustrating an embodiment of a second grounding conductor layer.

FIG. 3A is a top view illustrating an embodiment of a transmissive filter included in the antenna structure illustrated in FIG. 1, and FIG. 3B is a bottom view illustrating the embodiment of the transmissive filter included in the antenna structure illustrated in FIG. 1.

FIG. 4A is a top view illustrating an embodiment of an electromagnetic wave guiding layer included in the antenna structure illustrated in FIG. 1, and FIG. 4B is a bottom view illustrating the embodiment of the electromagnetic wave guiding layer included in the antenna structure illustrated in FIG. 1.

FIG. 5 is a perspective view illustrating an embodiment of a control substrate included in the antenna structure illustrated in FIG. 1.

FIG. 6A is a top view illustrating another embodiment of the transmissive filter included in the antenna structure illustrated in FIG. 1, and FIG. 6B is a bottom view illustrating the another embodiment of the transmissive filter included in the antenna structure illustrated in FIG. 1.

### DESCRIPTION OF EMBODIMENTS

As described above, the conventional antenna structure has a structure in which an electric filter substrate is layered on an upper surface of a control substrate (RF control substrate) and an antenna substrate is layered on an upper surface of the electric filter substrate. For this reason, as described above, the yield may decrease, the cost may increase, or each member cannot be applied in an arbitrary size according to an arrangement location. Therefore, there is a need for an antenna structure that has a low transmission loss, a high yield, and a low cost and in which each member can be applied with an arbitrary size according to an arrangement location.

An antenna structure according to the present disclosure includes a transmissive filter located over a first surface of an antenna substrate, and at least one control substrate located on a second surface of the antenna substrate. In addition, the antenna structure according to the present disclosure is not an integrated laminate of the antenna substrate, the control substrate, and the transmissive filter, but has a structure in which individual members are bonded. Therefore, according to the present disclosure, it is possible to provide an antenna structure that has a low transmission loss, a high yield, and a low cost and in which each member can be applied with an arbitrary size according to an arrangement location.

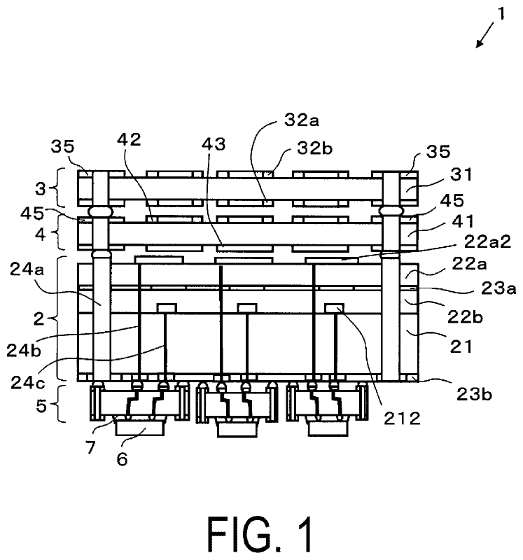

An antenna structure according to an embodiment of the present disclosure will be described below with reference to FIGS. 1 to 5. As illustrated in FIG. 1, an antenna structure 1 according to an embodiment includes an antenna substrate 2, a transmissive filter 3, an electromagnetic wave guiding layer 4, and a control substrate 5.

The antenna substrate 2 has a structure in which second antenna conductors 212, an insulating layer (second insulating layer) 22b, a first grounding conductor layer 23a, an insulating layer (first insulating layer) 22a, and first antenna conductors 22a2 are layered in this order on an upper surface of an insulating substrate 21 and a second grounding conductor layer 23b is layered on a lower surface of the insulating substrate 21. Furthermore, the antenna substrate 2 includes grounding/power supply through-hole conductors 24a penetrating through upper and lower surfaces of the antenna substrate 2, first through-hole conductors 24b each electrically connecting the corresponding first antenna conductor 22a2 and the corresponding control substrate 5, and second through-hole conductors 24c each electrically connecting the corresponding second antenna conductor 212 and the corresponding control substrate 5. The grounding/power supply through-hole conductor 24a, the first through-hole conductor 24b, and the second through-hole conductor 24c are formed of a metal such as copper.

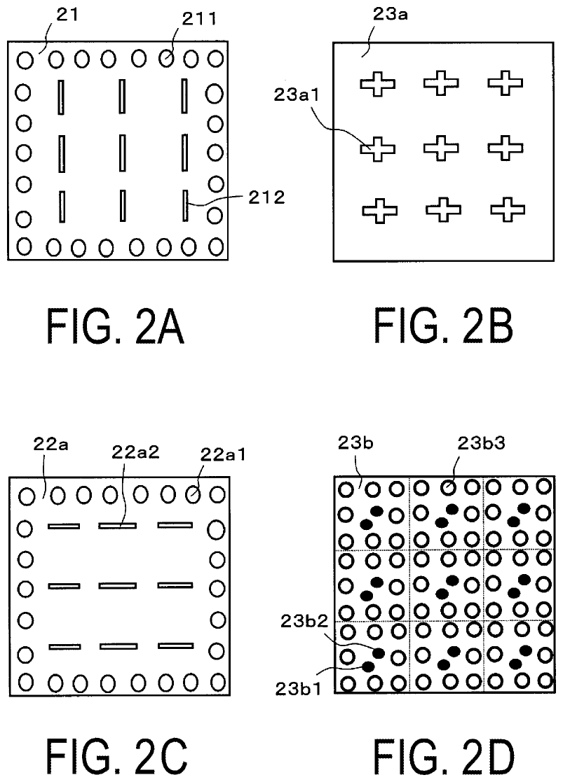

The antenna substrate 2 will be specifically described with reference to FIGS. 2A to 2D. FIG. 2A is a top view illustrating an embodiment of the insulating substrate 21 included in the antenna substrate 2. The insulating substrate 21 is not particularly limited as long as it is formed of a material having an insulating property. Examples of a material having an insulating property include resins such as an epoxy resin, a bismaleimide-triazine resin, a polyimide resin, and a polyphenylene ether resin. Two or more of these resins may be mixed and used.

The insulating substrate 21 may contain a reinforcing material. Examples of the reinforcing material include insulation fabric materials such as glass fiber, glass non-woven fabric, aramid non-woven fabric, aramid fiber, and polyester fiber. Two or more types of reinforcing materials may be used in combination. In addition, an inorganic insulating filler made of silica, barium sulfate, talc, clay, glass, calcium carbonate, titanium oxide, or the like may be dispersed in the insulating substrate 21.

On the upper surface of the insulating substrate 21, the second antenna conductors 212 are located and pads 211 are located in a peripheral edge portion of the insulating substrate 21 so as to surround the second antenna conductors 212. The second antenna conductor 212 and the pad 211 are not limited as long as they are formed of a material having electrical conductivity. Examples of a material having electrical conductivity include metals such as copper. Specifically, the second antenna conductor 212 and the pad 211 are formed of a metal foil such as a copper foil or metal plating such as copper plating.

The second antenna conductor 212 has, for example, a vertically straight line shape and is provided so as to receive and transmit electromagnetic waves.

The insulating layer 22b is located so as to cover the upper surface of the insulating substrate 21, the second antenna conductors 212, and the pads 211. Similarly to the insulating substrate 21, the insulating layer 22b is formed of a material having an insulating property as described above and may contain a reinforcing material and an inorganic insulating filler as described above.

The first grounding conductor layer 23a is located on an upper surface of the insulating layer 22b. FIG. 2B is a top view illustrating an embodiment of the first grounding conductor layer 23a included in the antenna substrate 2. The first grounding conductor layer 23a is not limited as long as it is formed of a conductor, and is formed of, for example, a metal foil such as a copper foil or metal plating such as copper plating.

The first grounding conductor layer 23a is provided with slots 23a1 each substantially facing a place where the corresponding second antenna conductor 212 and the corresponding first antenna conductor 22a2 to be described later are located. The slot 23a1 has a cross shape, in conformity to shapes of the second antenna conductor 212 having a vertically straight line shape and the first antenna conductor 22a2 having a horizontally straight line shape. The slot 23a1 is formed by, for example, etching a solid conductor that is a precursor of the first grounding conductor layer 23a.

The insulating layer 22a is located on an upper surface of the first grounding conductor layer 23a. FIG. 2C is a top view illustrating an embodiment of the insulating layer 22a included in the antenna substrate 2. On an upper surface of the insulating layer 22a, the first antenna conductors 22a2 are located and pads 22a1 are located in a peripheral edge portion of the insulating layer 22a so as to surround the first antenna conductors 22a2. Similarly to the second antenna conductor 212 and the pad 211, the first antenna conductor 22a2 and the pad 22a1 are formed of a metal such as copper, specifically, a metal foil such as a copper foil or metal plating such as copper plating.

The first antenna conductor 22a2 has a horizontally straight line shape and is located at a position facing the second antenna conductor 212 so as to intersect the second antenna conductor 212. That is, the first antenna conductor 22a2 and the second antenna conductor 212 form a cross shape in a plane perspective.

The antenna substrate 2 may have a configuration that allows transmission and reception of only radio waves in one frequency band when radio waves having different frequencies are mixed. That is, it is preferable that the antenna substrate has a resonance point limited by adjusting arrangement or the like of the first antenna conductors 22a2, the second antenna conductors 212, and the slots 23a1. When the antenna substrate 2 has a configuration that allows transmission and reception of only radio waves in one frequency band, the structure of the antenna structure 1 can be further simplified, which can contribute to, for example, miniaturization.

On the other hand, the second grounding conductor layer 23b is located on the lower surface of the insulating substrate 21. FIG. 2D is a top view illustrating an embodiment of the second grounding conductor layer 23b included in the antenna substrate 2. Furthermore, on the lower surface of the insulating substrate 21, a first electrode 23b1, a second electrode 23b2, and a power supply conductor 23b3 are located with a clearance from the second grounding conductor layer 23b to ensure insulating properties. The first electrode 23b1 is connected to the first antenna conductor 22a2 via the first through-hole conductor 24b. The second electrode 23b2 is connected to the second antenna conductor 212 via the second through-hole conductor 24c.

In the antenna substrate 2, one set of the first electrode 23b1 and the second electrode 23b2 is located in a region facing the corresponding set of the first antenna conductor 22a2 and the second antenna conductor 212. Specifically, there are nine sets of the first antenna conductor 22a2 and the second antenna conductor 212, and as illustrated in FIG. 2D, one set of the first electrode 23b1 and the second electrode 23b2 is located in the corresponding region of the nine regions. The power supply conductors 23b3 are located in a peripheral edge portion of each region so as to surround one set of the first electrode 23b1 and the second electrode 23b2.

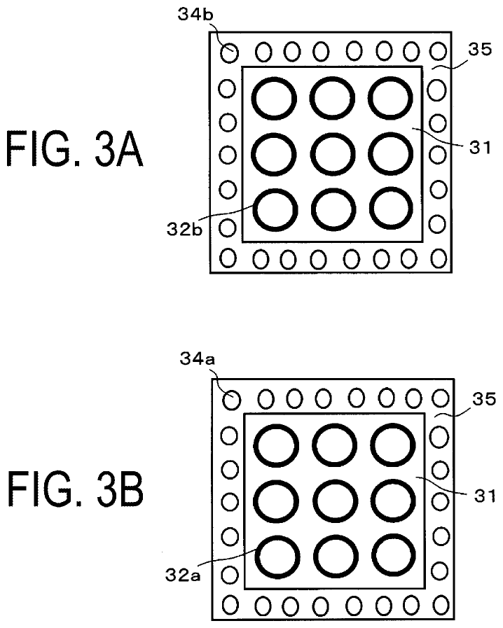

Next, the transmissive filter 3 will be described. As illustrated in FIG. 1, the transmissive filter 3 is located over a first surface (upper surface) of the antenna substrate 2 with the electromagnetic wave guiding layer 4 described later interposed therebetween. As illustrated in FIG. 1, the transmissive filter 3 includes an insulating substrate 31, first annular patterns 32a located on a lower surface (a surface on the antenna substrate 2 side) of the insulating substrate 31, and second annular patterns 32b located on an upper surface (a surface on an opposite side to the antenna substrate 2 side) of the insulating substrate 31. The transmissive filter 3 will be specifically described with reference to FIG. 3.

FIG. 3A is a top view illustrating an embodiment of the transmissive filter 3 included in the antenna structure 1, and FIG. 3B is a bottom view illustrating the embodiment of the transmissive filter 3 included in the antenna structure 1. As illustrated in FIG. 3A, on the upper surface of the insulating substrate 31, the second annular patterns 32b are located and second grounding pads 34b are located in a peripheral edge portion of the insulating substrate 31 so as to surround the second annular patterns 32b.

Similarly to the insulating substrate 21 described above, the insulating substrate 31 is not particularly limited as long as it is a material having an insulating property, and may further contain a reinforcing material or an inorganic insulating filler.

The second annular pattern 32b is located in a region facing the corresponding set of the first antenna conductor 22a2 and the second antenna conductor 212 described above. The second annular pattern 32b has a circular ring shape and is formed of a metal such as copper, specifically, a metal foil such as a copper foil or metal plating such as copper plating. The shape of the second annular pattern 32b is not limited to a circular ring shape, and is not limited as long as it has an annular shape.

In the present embodiment, the second grounding pad 34b is not a pad for electrically connecting members, but is used for simply connecting members. For this reason, the second grounding pad 34b may be formed of a metal such as copper, or may be formed of a resin.

A solder resist 35 is formed in the peripheral edge portion of the insulating substrate 31. The solder resist 35 has an opening through which the second grounding pad 34b is exposed. The solder resist 35 is formed of, for example, an acryl-modified epoxy resin.

On the other hand, as illustrated in FIG. 3B, on the lower surface of the insulating substrate 31, the first annular patterns 32a are located and first grounding pads 34a are located in the peripheral edge portion of the insulating substrate 31 so as to surround the first annular patterns 32a.

The first annular pattern 32a is located so as to face the second annular pattern 32b with the insulating substrate 31 interposed therebetween. In other words, the first annular pattern 32a and the second annular pattern 32b are located so as to entirely overlap each other in a plane perspective. Similarly to the second annular pattern 32b, the first annular pattern 32a also has a circular ring shape and is formed of a metal such as copper, specifically, a metal foil such as a copper foil or metal plating such as copper plating. The shape of the first annular pattern 32a is not limited to a circular ring shape, and is not limited as long as it has an annular shape.

In the present embodiment, the first grounding pad 34a located on the lower surface of the insulating substrate 31 is not a pad for electrically connecting members, but is used for simply connecting members. For this reason, the first grounding pad 34a located on the lower surface of the insulating substrate 31 may also be made of a metal such as copper, or a resin.

Similarly to the peripheral edge portion of the upper surface of the insulating substrate 31, the solder resist 35 is also formed in a peripheral edge portion of the lower surface of the insulating substrate 31. The solder resist 35 located on the lower surface of the insulating substrate 31 also has an opening through which the first grounding pad 34a is exposed. As described above, the solder resist 35 is formed of, for example, an acryl-modified epoxy resin.

When a pattern is formed in an annular shape like the first annular pattern 32a and the second annular pattern 32b included in the transmissive filter 3, it is possible to intensify radio waves and to reduce mixing of radio waves with the adjacent annular pattern. As illustrated in FIGS. 3A and 3B, the first annular pattern 32a and the second annular pattern 32b each have a circular shape, and therefore, the effects are further exhibited.

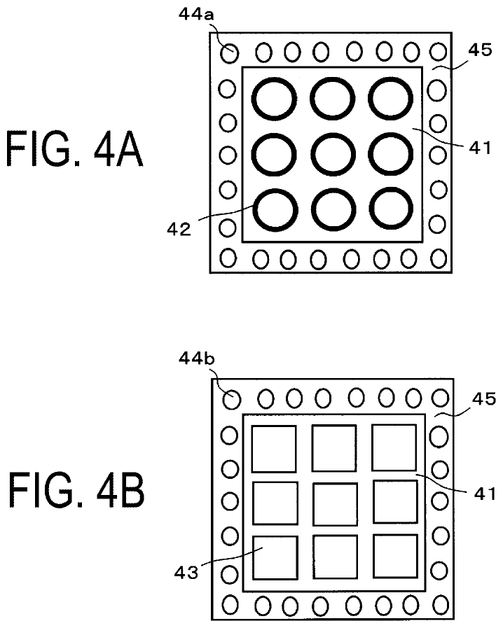

As illustrated in FIG. 1, the electromagnetic wave guiding layer 4 interposed between the antenna substrate 2 and the transmissive filter 3 includes an insulating substrate 41, third annular patterns 42 located on an upper surface (a surface on the transmissive filter 3 side) of the insulating substrate 41, and electromagnetic wave guiding electrodes 43 located on a lower surface (a surface on the antenna substrate 2 side) of the insulating substrate 41. The electromagnetic wave guiding layer 4 is used to more efficiently guide radio waves from the antenna substrate 2 to the transmissive filter 3, or to more efficiently guide radio waves transmitting through the transmissive filter 3 from the outside to the antenna substrate 2. The electromagnetic wave guiding layer 4 will be specifically described with reference to FIG. 4.

FIG. 4A is a top view illustrating an embodiment of the electromagnetic wave guiding layer 4 included in the antenna structure 1, and FIG. 4B is a bottom view illustrating the embodiment of the electromagnetic wave guiding layer 4 included in the antenna structure 1. As illustrated in FIG. 4A, on the upper surface of the insulating substrate 41, the third annular patterns 42 are formed and third grounding pads 44a are formed in a peripheral edge portion of the insulating substrate 41 so as to surround the third annular patterns 42.

Similarly to the insulating substrate 21 described above, the insulating substrate 41 is not particularly limited as long as it is a material having an insulating property, and may further contain a reinforcing material or an inorganic insulating filler.

The third annular patterns 42 are identical in number to the first annular patterns 32a, and are each located so as to face the corresponding first annular pattern 32a. Similarly to the first annular pattern 32a, the third annular pattern 42 also has a circular shape and is formed of a metal such as copper, specifically, a metal foil such as a copper foil or metal plating such as copper plating. The shape of the third annular pattern 42 is not limited to a circular ring shape and is not limited as long as it has an annular shape.

In the present embodiment, the third grounding pad 44a is not a pad for electrically connecting members, but is used for simply connecting members. For this reason, the third grounding pad 44a may be made of a metal such as copper, or a resin.

A solder resist 45 is formed in the peripheral edge portion of the insulating substrate 41. The solder resist 45 has an opening through which the third grounding pad 44a is exposed. As described above, the solder resist 45 is formed of, for example, an acryl-modified epoxy resin.

On the other hand, as illustrated in FIG. 4B, on the lower surface of the insulating substrate 41, the electromagnetic wave guiding electrodes 43 are located and fourth grounding pads 44b are located in the peripheral edge portion of the insulating substrate 41 so as to surround the electromagnetic wave guiding electrodes 43.

The electromagnetic wave guiding electrodes 43 are identical in number to the third annular patterns 42, and are each located so as to face the corresponding third annular pattern 42 with the insulating substrate 41 interposed therebetween. A shape of the electromagnetic wave guiding electrode 43 is not an annular shape but a planar quadrangular shape. The shape of the electromagnetic wave guiding electrode 43 may also be a polygon other than a quadrangle, or a circle. The electromagnetic wave guiding electrode 43 is formed of a metal such as copper, specifically, a metal foil such as a copper foil or metal plating such as copper plating.

In the present embodiment, the fourth grounding pad 44b located on the lower surface of the insulating substrate 41 is not a pad for electrically connecting members, but is used for simply connecting members. For this reason, the fourth grounding pad 44b may also be made of a metal such as copper, or a resin.

As in the peripheral edge portion of the upper surface of the insulating substrate 41, the solder resist 45 is also formed in a peripheral edge portion of the lower surface of the insulating substrate 41. The solder resist 45 located on the lower surface of the insulating substrate 41 also has an opening through which the fourth grounding pad 44b is exposed. As described above, the solder resist 45 is formed of, for example, an acryl-modified epoxy resin.

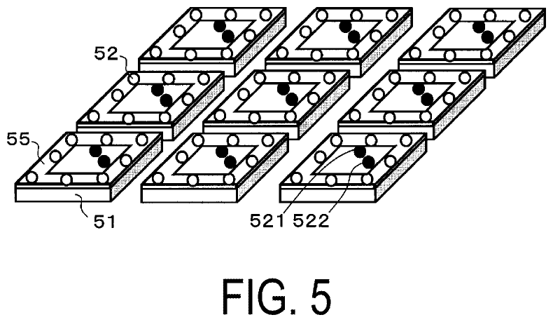

Next, the control substrates 5 located on a second surface (lower surface) of the antenna substrate 2 will be specifically described with reference to FIG. 5. FIG. 5 is a perspective view illustrating an embodiment of the control substrates 5 included in the antenna structure 1. The control substrates 5 are identical in number to the first annular patterns 32a, and are each located so as to face the corresponding first annular pattern 32a. In the present embodiment, nine individual control substrates 5 are arranged in three rows and three columns. As illustrated in FIG. 5, the control substrate 5 includes an insulating substrate 51, and grounding/power supply electrodes 52, a third electrode 521, and a fourth electrode 522 located on an upper surface of the insulating substrate 51, and is further provided with a control circuit (not illustrated). The control substrate 5 functions to control an intensity of electromagnetic waves or timings of transmission and reception of the electromagnetic waves.

Similarly to the insulating substrate 21 described above, the insulating substrate 51 is not particularly limited as long as it is a material having an insulating property, and may further contain a reinforcing material or an inorganic insulating filler.

The grounding/power supply electrodes 52 are located in a peripheral edge portion of the insulating substrate 51 so as to surround the third electrode 521 and the fourth electrode 522. The grounding/power supply electrode 52 is formed of a metal such as copper, specifically, a metal foil such as a copper foil or metal plating such as copper plating.

The third electrode 521 is connected to the first antenna conductor 22a2 via the first electrode 23b1 and the first through-hole conductor 24b. The fourth electrode 522 is connected to the second antenna conductor 212 via the second electrode 23b2 and the second through-hole conductor 24c. The third electrode 521 and the fourth electrode 522 are formed of a metal such as copper, specifically, a metal foil such as a copper foil or metal plating such as copper plating.

A solder resist 55 is formed in a peripheral edge portion of an upper surface of the insulating substrate 51. The solder resist 55 has an opening through which the grounding/power supply electrode 52 is exposed. As described above, the solder resist 55 is formed of, for example, an acryl-modified epoxy resin.

As illustrated in FIG. 1, semiconductor elements 6 are mounted on a lower surface of the control substrate 5. A gap between the control substrate 5 and each of the semiconductor elements 6 is filled with a sealing resin 7.

The present disclosure is not limited to the antenna structure 1 according to the embodiment described above, and various modifications can be made without departing from the scope of the present disclosure. For example, the transmissive filter 3 may be provided with grounding wiring lines 341 (a first grounding wiring line 341a and a second grounding wiring line 341b) to discharge electromotive current. The grounding wiring line 341 is formed of a metal such as copper, specifically, a metal foil such as a copper foil or metal plating such as copper plating.

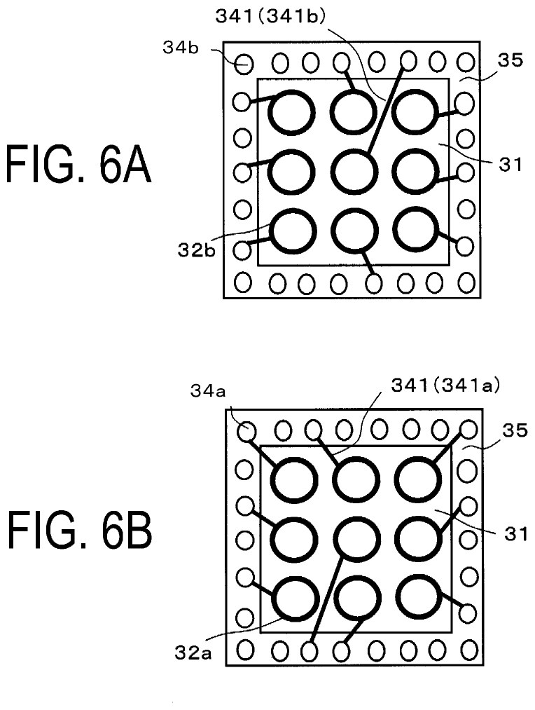

As illustrated in FIGS. 6A and 6B, the grounding wiring lines 341 are located on both surfaces (upper and lower surfaces) of the insulating substrate 31 included in the transmissive filter 3. The second grounding wiring line 341b located on the upper surface of the insulating substrate 31 is located so as to connect the second annular pattern 32b and the second grounding pad 34b. The grounding pad 34 to which the second grounding wiring line 341b is connected is preferably formed of a metal such as copper.

The first grounding wiring line 341a located on the lower surface of the insulating substrate 31 is formed so as to connect the first annular pattern 32a and the first grounding pad 34a. The first grounding pad 34a to which the first grounding wiring line 341a is connected is preferably made of a metal such as copper. The first grounding pad 34a and the second grounding pad 34b are electrically connected via, for example, a via hole conductor located in the insulating substrate 31.

The antenna structure 1 according to the embodiment described above has a structure in which one transmissive filter 3 is layered. However, the antenna structure of the present disclosure may have a structure in which two or more transmissive filters are layered.

In the antenna structure 1 according to the embodiment described above, the solder resists are formed on the upper and lower surfaces of the transmissive filter 3, the upper and lower surfaces of the electromagnetic wave guiding layer 4, and the upper surface of the control substrate 5. However, in the antenna structure of the present disclosure, the solder resists are not essential members and may be used as necessary.

The electromagnetic wave guiding layer 4 is used in the antenna structure 1 according to the embodiment described above. However, in the antenna structure of the present disclosure, the electromagnetic wave guiding layer is not an essential member and may be used as necessary.

### REFERENCE SIGNS

1 Antenna structure
2 Antenna substrate
21 Insulating substrate
211 Pad
212 Second antenna conductor
22a First insulating layer
22a1 Pad
22a2 First antenna conductor
22b Second insulating layer
23a First grounding conductor layer
23a1 Slot
23b Second grounding conductor layer
23b1 First electrode
23b2 Second electrode
23b3 Power supply conductor
24a Grounding/power supply through-hole conductor
24b First through-hole conductor
24c Second through-hole conductor
3 Transmissive filter
31 Insulating substrate
32a First annular pattern
32b Second annular pattern
34 Grounding pad
34a First grounding pad
34b Second grounding pad
341 Grounding wiring line
341a First grounding wiring line
341b Second grounding wiring line
35 Solder resist
4 Electromagnetic wave guiding layer
41 Insulating substrate
42 Third annular pattern
43 Electromagnetic wave guiding electrode
44a Third grounding pad
44b Fourth grounding pad
45 Solder resist
5 Control substrate
51 Insulating substrate
52 Grounding/power supply electrode
521 Third electrode
522 Fourth electrode
55 Solder resist
6 Semiconductor element
7 Sealing resin

1. An antenna structure comprising:
an antenna substrate comprising a first surface and a second surface located on an opposite side to the first surface;
a transmissive filter located over the first surface; and
a control substrate located on the second surface,
wherein the transmissive filter comprises a first annular pattern located on a surface facing the first surface, and a second annular pattern located on a surface on an opposite side to the surface facing the first surface,
the first annular pattern and the second annular pattern are located overlapping each other in a plane perspective, and
the control substrate is identical in number to the first annular pattern, and is located overlapping the first annular pattern in a plane perspective.

2. The antenna structure according to claim 1, further comprising an electromagnetic wave guiding layer located between the antenna substrate and the transmissive filter.

3. The antenna structure according to claim 2, wherein the electromagnetic wave guiding layer comprises a third annular pattern on a surface on a side of the transmissive filter, the third annular pattern being identical in number to the first annular pattern and being located facing the first annular pattern, and comprises an electromagnetic wave guiding electrode on a surface on an opposite side, the electromagnetic wave guiding electrode being identical in number to the third annular pattern and being located overlapping the third annular pattern in a plane perspective.

4. The antenna structure according to claim 1, wherein, in the transmissive filter, a first grounding pad is further located in a peripheral edge portion of a surface on the antenna substrate side, and a second grounding pad is further located in a peripheral edge portion of a surface on an opposite side, the first annular pattern and the first grounding pad are connected via a first grounding wiring line, and the second annular pattern and the second grounding pad are connected via a second grounding wiring line.

5. The antenna structure according to claim 1, wherein the first annular pattern, the second annular pattern, and the third annular pattern each have a circular ring shape.

6. The antenna structure according to claim 1, wherein two or more layers of the transmissive filter are layered.

7. The antenna structure according to claim 1, wherein at least one selected from the group consisting of the first annular pattern, the second annular pattern, the third annular pattern, the first grounding pad, the second grounding pad, the first grounding wiring line, and the second grounding wiring line is made of copper.
